(19) United States
(12) Patent Application Publication
(10) Pub. No.: US 2007/0011925 A1
(43) Pub. Date: Jan. 18, 2007

(54) Rack simulating tire stack for signage mount

(76) Inventor: Kelly Christopher Edwards, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/484,982

(22) Filed: Jul. 11, 2006

Related U.S. Application Data
(60) Provisional application No. 60/700,494, filed on Jul. 18, 2005.

(51) Int. Cl. G09F 17/00

(52) U.S. Cl. 40/604

(57) ABSTRACT

An engaging rack for engagement with a cylindrical banner adapted for mounting on a tire stack. The rack features top and bottom components having a circular perimeter edge substantially the diameter of a tire. At least one elongated member engages between the top component and the bottom component with the resulting rack dimensioned to provide a mount for said cylindrical banner conventionally engaged over stacks of tires. Rollers may be engaged for easy transport and the elongated members may be telescopic to adjust height. The device may be provided in kit form with different diameters for the top and bottom components to adjust the rack for ultimate dimension to accommodate various sized tire stack banners.

This application claims priority from U.S. provisional application Ser. No. 60/700,494, filed Jul. 18, 2005.

### BACKGROUND OF THE INVENTION

1. Field of the Invention

The present invention relates to a rolling frame for three-dimensional signage. More particularly it relates to a cylindrical dimensioned rolling frame having dimensional characteristics to approximate a stack of tires adapted to engage cylindrical banners provided by tire manufacturers to advertise their products.

2. Prior Art

Tire manufacturers, in their quest to advertise products to the purchasing public, have evolved in recent years a banner program wherein they distribute free advertising banners and signage to their dealers. This signage is generally silk screened vinyl or canvas formed into a cylindrical shape and thereby adapted by design to slide onto a stack of tires which are generally plentiful at tire dealers.

Unfortunately, mounting and unmounting these complimentary signs provided by the manufacturers is a time-consuming process. In order to provide a proper mount for the cylindrical or tube-shaped fabric banners, tires must be stacked up to the proper height to support the slide-on banner. Every day, an employee of the tire dealer must roll the tires out of the shop, stack them up to the proper height, and then slide the cylindrical fabric banner sign on the stack. In an equally time-consuming process, at the end of the day the banner must be removed and the tires unstacked and taken back inside. Additionally, by design or accident of the manufacturers chosen method of providing signage, using a plurality of tires to make the stack takes up valuable inventory.

As such, there exists a continuing unmet need for a fabric signage support that will simulate a stack of tires thereby allowing tire distributors to use the complimentary signage provided by manufacturers without tying up inventory. Such a device should have height and diameter characteristics that will accommodate the mounting of most cylindrical banners upon them while concurrently making the banner appear to be mounted on a tire stack. Such a device should be easily wheeled in and out of a store for use and should not require nightly mounting and dismounting of the banner itself. Further, such a device should optionally provide for backlighting and means for engagement of the banner itself not currently provided.

### SUMMARY OF THE INVENTION

The device herein disclosed and described is a circular or cylindrical shaped rack adapted for the interior engagement of cylindrical shaped signage printed on flexible material or vinyl. The device has a frame having a height and diameter about the size of an average tire. On a bottom portion of the device at least two wheels provide a means for rolling the device to and from a display position in front of a business to a storage position inside the business. Vertical supports are engaged with circular top and bottom and optional middle frame layers that are circular in shape. The device is thus adapted to simulate a stack of tires and to accept the manufacturer's free cylindrical banners for mounting thereon, thereby giving customers the illusion that the banner is mounted on a tire stack. Because it has wheels, it is easy to move in and out of the business, and the cylindrical banner can remain permanently mounted on the device without tying up tire inventory for the formerly required tire stack.

Further, the device would optionally have a means to engage the banner at a low point on the device to maintain it in a mounted position thereon. An inflatable tube would work especially well and would inflate to compress against and hold the cylindrical banner. A recess or other mounting fixture can also be provided in addition to, or in lieu of, the inflatable mount to allow for connection of the open bottom end of the banner to the device to keep it from coming off in wind and to maintain a taught look for the signage. Additionally, the device can have an internal light affixed that will backlight the cylindrical banner making it more visible especially at night. Or the device could have a transparent top component and reflective rear component which would allow sunlight into it, thus backlighting the mounted signage.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is e capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide a frame adapted in dimension to simulate a stack of tires and thereby provide a mount for flexible banners and signage currently being mounted on tire stacks.

It is another object of this invention to provide such a frame which will roll allowing easy transport from a stored position to a display position.

It is a further object of this invention to provide such a rack having the dimensional characteristics of a stack of tires but also having means to engage the banner slipped thereover.

An additional object of this invention is the provision of natural or artificial backlighting of an engaged banner.

Further objects of the invention will be brought out in the following part of the specification, wherein detailed description is for the purpose of fully disclosing the invention without placing limitations thereon.

### BRIEF DESCRIPTION OF DRAWING FIGURES

FIG. 1 depicts a perspective view of the disclosed rack that is formed of a top frame section, a bottom frame section and a plurality of uprights spacing the two frame sections to approximate a tire stack.

FIG. 2 is a side view of the device showing the top and bottom frames engaged by uprights and optional inflational means to engage a flexible banner slipped over the frame.

FIG. 3 depicts an embodiment of the device having an open or transparent top frame and reflective rear component to allow for sunlight to backlight a banner engaged on the frame.

FIG. 4 shows an embodiment of the device with an artificial light source that can optionally be used to light the banner engaged on the frame.

FIG. 5 depicts the device with a banner engaged thereon and simulating a tire stack having a banner upon it.

### DETAILED DESCRIPTION OF THE PREFERRED EMBODIMENTS OF THE INVENTION

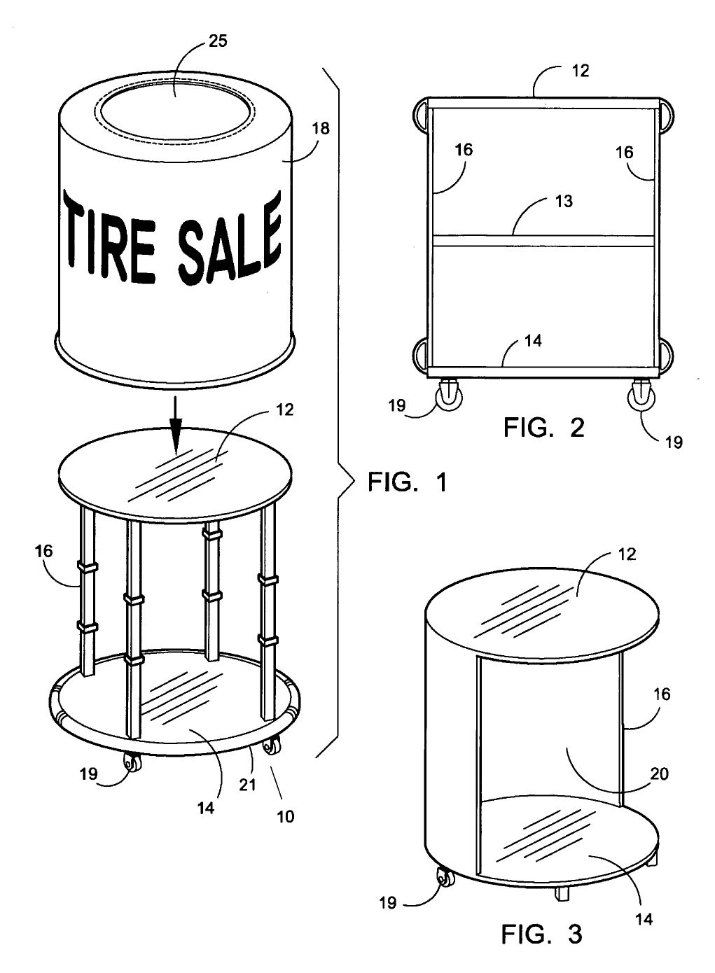

As shown in FIGS. 1-5 the device in FIG. 1 depicts a perspective view of the disclosed tire stack rack device 10 that is formed of top frame section 12, a bottom frame section 14 and a plurality of vertical members 16 spacing the two frame sections in a fixed engagement to thereby form the device 10 to a framework that approximates a tire stack. The top frame section 12 and bottom frame section 14 as shown are planar components with a planar section extending to a circular perimeter. However, the circular perimeter for both frame sections can also be formed by a hollow ring or a donut shaped component with the important factor being that the perimeter be substantially circular and that the diameter of both sections be slightly smaller than the diameter of any banner 18 affixed thereover. However, the current preferred mode includes a planar surface on at least the bottom frame section to provide a surface for storage and/or weighting the device 10 to guard against tipping over in high winds or during rolling.

At least one vertical member 16 and preferably a plurality of such vertical members 16 engage both the top frame section 12 and bottom frame section 14 in a spaced arrangement to simulate the tire stack. Such a plurality of members 16, in addition to spacing the top frame section 12 and bottom frame section 14 in a registered engagement, also provides a means to prevent the banner 18 from collapsing when engaged over the device 10.

The banner 18 would generally be provided by manufacturers seeking to advertise their goods but can also be included as a component of the device 10. Conventional style tire banners are generally designed to slip over a stack of tires and once so engaged appear as a cylindrical sign advertising the products. Such banners generally frictionally engage about the outside of the stack of tires and the device 10 therefore would replace the aforementioned time-consuming stacking and unstacking of tires and waste of inventory while still allowing the user to employ conventional promotional banners provided by tire manufacturers. In addition, the banner 18 can be included with the device 10 as an option.

FIG. 2 is a side view of the device 10 showing the top and bottom frame sections 12 and 14 engaged by vertical members 16. The members 16 may be fixed in length, and in a particularly preferred mode of the device 10, they can be telescopic to allow for different sized banners 18 and to allow the device to collapse to a very small size for storage. Also in another preferred mode of the device 10, an inflational means to engage the interior of a flexible banner 18 slipped over the device 10, which in this case is similar to a tire tube and shown as inflatable tube 21, can be provided to secure the banner 18 over the device 10. The tube 21 would be inflated with compressed air to enlarge and compressibly engage the interior of the tube shaped banner 18 and hold it on the device 10. Compressed air works best as tire stores have tubes in stock and a supply of compressed air to fill them.

Also shown in FIG. 2 is the optional center frame 13 that can be provided and employed with a banner 18 with an open back or aperture on one side, to thereby provide a shelf inside the device 10 for sales literature. Also shown in the various figures are wheels 19 or casters or other means to render the device 10 rollable from its storage point to its display point in front of a business or tire shop.

Currently, the top frame section 12 and bottom frame section would work best from about twenty-six to twenty-eight inches in diameter and the vertical members 16 spacing the two frame sections by about forty-five inches to achieve an average sized tire stack approximation. Of course other dimensions could be used and because the device is not heavy or hard to move like tires being stacked, the device 10 itself can open up the dimensions to larger sizes than currently used since at present the sizes are limited by the weight and size of the tires used for a stack. The device 10 eliminates that problem as it is lightweight and can roll, and if telescopic members 16 are employed the height can vary to any height desirable.

Further, the device can be assembleable as a kit, having a plurality of different diameter top frame sections 12 and bottom frame sections 14 to allow the user to assemble different diameter devices 10 to accommodate different diameter banners 18, and if the kit employs the telescopic version of the members 16, both the height and the diameter of the resulting device 10 can be varied by the user by simply changing the components. In this kit mode of the device 10 the user will have the ability to use any size banner 18 that the diameters of the top frame and bottom frame sections will engage and the length of the members will accommodate for height.

FIG. 3 depicts an embodiment of the device 10 having an open or transparent top frame section 12 which allows light to pass therethrough from sun or an exterior source. A reflective rear component 20 can be provided which would engage around a portion of the rear perimeter of the device 10 to provide a means to reflect natural or artificial light transmitted from a light source through a top section 25 in the top surface of the banner 18 engaged on the device 10 thereby increasing visibility, especially at night, by backlighting the opaque banner material 18. The banner 18 engaged on this mode of the device 10 would either have a substantially transparent top section 25 that is either an aperture or substantially transparent material to pass light therethrough.

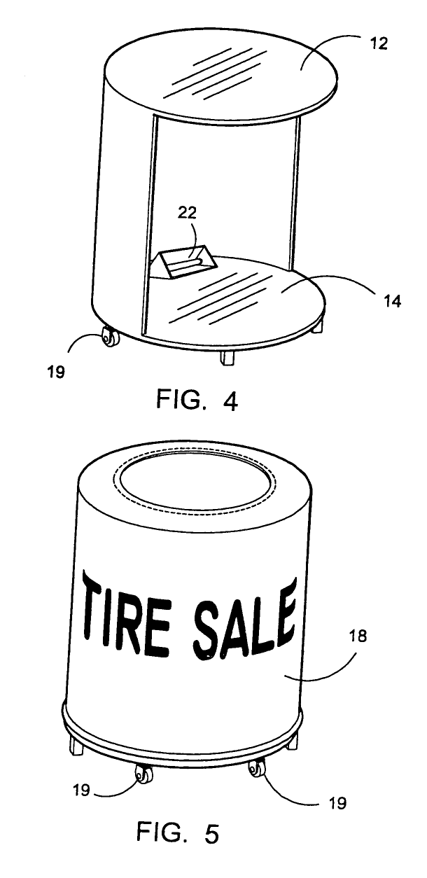

The light source might also be mounted in the device 10 such as shown in FIG. 4 where an artificial light source 22 is provided. This could be used with or without the rear component 20 and with or without the void in the top section of the banner. Both modes of the back lighting, like all others herein, can also be provided in the kit form with different dimensioned rear components 20 adapted to engage the differing sized top and bottom frame diameters in the kit and different lengths of the vertical members 16 or telescopic vertical members 16.

Finally, FIG. 5 depicts the device 10 in the assembled mode showing the banner 18 engaged thereon with the device 10 dimensioned to simulate a tire stack of a diameter and height to accommodate the banner 18. As shown, the assembled mode can be accomplished using the kit form of the device and assembling the various components of proper size or in a mode of the device 10 that is of a single dimension that is adapted to fit most conventionally dimensioned tire stack banners 18 currently in use. It should be noted that either the use of telescopic members 16 or the kit form with different diametered components will provide the most versatility to the user and allow for bigger and more noticeable signage. However, even the basic mode of the device 10 as noted is a vast improvement over the current system of tying up inventory in the laborious job of stacking tires to provide a banner mount.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An engaging rack for engagement with a cylindrical banner adapted for mounting on a tire stack, comprising:
a top component having a circular perimeter edge;
a bottom component having a circular perimeter edge;
at least one elongated member engaged between said top component and said bottom component; and
said diameter of said top component and said bottom component being dimensioned to a size adapted to thereby provide a mount for said cylindrical banner engaged thereover in a mounted position.

2. The engaging rack of claim 1, additionally comprising:
means for rolling said engaging rack.

3. The engaging rack of claim 1, additionally comprising:
said elongated member being telescopic and extendable to a plurality of lengths, thereby providing a means to vary distance between said top component and said bottom component.

4. The engaging rack of claim 2, additionally comprising:
said elongated member being telescopic and extendable to a plurality of lengths, thereby providing a means to vary distance between said top component and said bottom component.

5. The engaging rack of claim 1 additionally comprising:
means to backlight a front section of said cylindrical banner when in said mounted position.

6. The engaging rack of claim 2 additionally comprising:
means to backlight a front section of said cylindrical banner when in said mounted position.

7. The engaging rack of claim 3 additionally comprising:
means to backlight a front section of said cylindrical banner when in said mounted position.

8. The engaging rack of claim 4 additionally comprising:
means to backlight a front section of said cylindrical banner when in said mounted position.

9. The engaging rack of claim 5 wherein said means to backlight a front section of said cylindrical banner when in said mounted position includes:
a reflective component on a back section of said engaging rack; and
an a center section in said top component adapted to transmit light therethrough;
a top portion of said cylindrical banner adapted to transmit light therethrough, when in said mounted position, whereby light transmitted through said top component reflects from said reflective component and through a front section of said cylindrical banner opposite said back section of said engaging rack.

10. The engaging rack of claim 6 wherein said means to backlight a front section of said cylindrical banner when in said mounted position includes:
a reflective component on a back section of said engaging rack; and
an a center section in said top component adapted to transmit light therethrough;
a top portion of said cylindrical banner adapted to transmit light therethrough, when in said mounted position, whereby light transmitted through said top component reflects from said reflective component and through a front section of said cylindrical banner opposite said back section of said engaging rack.

11. The engaging rack of claim 7 wherein said means to backlight a front section of said cylindrical banner when in said mounted position includes:
a reflective component on a back section of said engaging rack; and
a center section in said top component adapted to transmit light therethrough;
a top portion of said cylindrical banner adapted to transmit light therethrough, when in said mounted position, whereby light transmitted through said top component reflects from said reflective component and through a front section of said cylindrical banner opposite said back section of said engaging rack.

12. The engaging rack of claim 8 wherein said means to backlight a front section of said cylindrical banner when in said mounted position includes:
a reflective component on a back section of said engaging rack; and
a center section in said top component adapted to transmit light therethrough;
a top portion of said cylindrical banner adapted to transmit light therethrough, when in said mounted position, whereby light transmitted through said top component reflects from said reflective component and through a front section of said cylindrical banner opposite said back section of said engaging rack.

13. The engaging rack of claim 5 wherein said means to backlight a front section of said cylindrical banner when in said mounted position comprises:
means for artificial light generation positioned between said top component and said bottom component.

14. The engaging rack of claim 6 wherein said means to backlight a front section of said cylindrical banner when in said mounted position comprises:
means for artificial light generation positioned between said top component and said bottom component.

15. The engaging rack of claim 1 provided in a kit form, said kit form comprising:
a plurality of said top components, each having a different diameter;
a plurality of said bottom components each having a different diameter, and
whereby, the diameter of said engaging rack can be adapted to operatively engage a plurality of said cylindrical banners in different diameters in said mounted position.

16. The engaging rack of claim 2 provided in a kit form, said kit form comprising:
a plurality of said top components, each having a different diameter;
a plurality of said bottom components each having a different diameter, and
whereby, the diameter of said engaging rack can be adapted to operatively engage a plurality of said cylindrical banners in different diameters, in said mounted position.

17. The engaging rack of claim 3 provided in a kit form, said kit form comprising:
a plurality of said top components, each having a different diameter;
a plurality of said bottom components each having a different diameter, and
whereby, the diameter of said engaging rack can be adapted to operatively engage a plurality of said cylindrical banners in different diameters and having different lengths, in said mounted position.

18. The engaging rack of claim 4 provided in a kit form, said kit form comprising:
a plurality of said top components, each having a different diameter;
a plurality of said bottom components each having a different diameter, and
whereby, the diameter of said engaging rack can be adapted to operatively engage a plurality of said cylindrical banners in different diameters and having different lengths, in said mounted position.

19. The engaging rack of claim 1 additionaly comprising:
said top component having a planar surface extending between said perimeter edge; and
said bottom component having a planar surface extending to said perimeter edge.

20. The engaging rack of claim 1 additionally comprising:
means to compressibly engage an interior surface of said banner when in said mounted position.

21. The engaging rack of claim 2 additionally comprising:
means to compressibly engage an interior surface of said banner when in said mounted position.

23. The engaging rack of claim 3 additionally comprising:
means to compressibly engage an interior surface of said banner when in said mounted position.
